(19) United States
(12) Patent Application Publication
(10) Pub. No.: US 2022/0314113 A1
(43) Pub. Date: Oct. 6, 2022

(54) GENERATING POINT CLOUD COMPLETION NETWORK AND PROCESSING POINT CLOUD DATA

(71) Applicant: SENSETIME INTERNATIONAL PTE. LTD., Singapore (SG)

(72) Inventors: Junzhe Zhang, Singapore (SG); Xinyi Chen, Singapore (SG); Zhongang Cai, Singapore (SG); Haiyu Zhao, Singapore (SG); Shuai Yi, Singapore (SG)

(21) Appl. No.: 17/362,752

(22) Filed: Jun. 29, 2021

Related U.S. Application Data
(63) Continuation of application No. PCT/IB2021/055011, filed on Jun. 8, 2021.

(30) Foreign Application Priority Data
Mar. 30, 2021 (SG) 10202103264X

(51) Int. Cl. A63F 13/355; G06T 17/00; A63F 13/40; A63F 13/69

(52) U.S. Cl. CPC A63F 13/355; G06T 17/00; A63F 13/40; A63F 13/69

(57) ABSTRACT

The embodiments of the present disclosure provide a method, an apparatus and a system for generating a point cloud completion network. The method includes: acquiring first point cloud data by inputting a latent space vector into a pre-trained first point cloud completion network; acquiring real point cloud data collected for a real object in a physical space; for a real point in the real point cloud data, selecting a preset number of points adjacent to the real point from the first point cloud data as neighbor points of the real point; generating second point cloud data based on the neighbor points in the first point cloud data of a plurality of real points; acquiring a second point cloud completion network by adjusting the first point cloud completion network based on a difference between the second point cloud data and the real point cloud data.

### CROSS REFERENCE TO RELATED APPLICATION

This application is a continuation application of International Application No. PCT/IB2021/055011 filed on Jun. 8, 2021, which claims priority to Singapore Patent Application No. 10202103264X, filed on Mar. 30, 2021, entitled “GENERATING POINT CLOUD COMPLETION NETWORK AND PROCESSING POINT CLOUD DATA” the disclosure of which is incorporated herein by reference in its entirety for all purposes.

### TECHNICAL FIELD

The present disclosure relates to the field of computer vision technology, in particular to methods, apparatuses and systems for generating a point cloud completion network and methods, apparatuses and systems for processing point cloud data.

### BACKGROUND

Point cloud completion is used to repair point cloud data which has lost some (that is, incomplete cloud data or defect cloud data), and estimate complete point cloud data based on the incomplete cloud data. Point cloud completion has been applied in many fields such as autonomous driving and robot navigation. Therefore, it is expected to improve the generation method of the point cloud completion network to improve the accuracy of the point cloud completion network.

### SUMMARY

The present disclosure provides a method, an apparatus and a system for generating a point cloud completion network and processing point cloud data.

According to a first aspect of the embodiments of the present disclosure, a method of generating a point cloud completion network is provided, including: acquiring first point cloud data by inputting a latent space vector into a pre-trained first point cloud completion network; acquiring real point cloud data collected for a real object in a physical space; for a real point in the real point cloud data, selecting a preset number of points adjacent to the real point are from the first point cloud data as neighbor points of the real point; generating second point cloud data based on the neighbor points in the first point cloud data of a plurality of real points; acquiring a second point cloud completion network by adjusting the first point cloud completion network based on a difference between the second point cloud data and the real point cloud data.

In some embodiments, the method further includes: acquiring third point cloud data; acquiring fourth point cloud data by completing the third point cloud data with the second point cloud completion network.

In some embodiments, the method further includes: acquiring raw point cloud data collected by a point cloud collecting device from the physical space; acquiring the third point cloud data by performing point cloud segmentation on the raw point cloud data.

In some embodiments, the method further includes: associating a plurality of frames of the fourth point cloud data.

In some embodiments, selecting the preset number of points adjacent to the real point are from the first point cloud data as neighbor points of the real point includes: selecting the preset number of points nearest to the real point from the first point cloud data as the neighbor points of the real point.

In some embodiments, generating second point cloud data based on the neighbor points in the first point cloud data of the plurality of real points includes: acquiring the second point cloud data by taking a union of the respective neighbor points of the plurality of real points in the real point cloud data.

In some embodiments, the method further includes: pre-training the first point cloud completion network based on complete point cloud data from a sample point cloud data set.

In some embodiments, the method further includes: acquiring a plurality of point cloud blocks in the first point cloud data; for each of the plurality of point cloud blocks, determining a points-distribution feature of the point cloud block; establishing a loss function based on respective points-distribution feature of the plurality of point cloud blocks; performing an optimization on the trained second point cloud completion network based on the loss function.

In some embodiments, the latent space vector is acquired based on the following method: sampling a plurality of initial latent space vectors from a latent space; for each of the initial latent space vectors, acquiring point cloud data generated by the first point cloud completion network based on the initial latent space vector; determining a target function of the initial latent space vector based on the point cloud data corresponding to the initial latent space vector and the real point cloud data; determining the latent space vector from the initial latent space vectors based on respective target functions of the initial latent space vectors.

According to a second aspect of the embodiments of the present disclosure, a method of processing point cloud data is provided, including: acquiring first to-be-processed point cloud data corresponding to a game participant in a game area and second to-be-processed point cloud data corresponding to a game object; acquiring first processed point cloud data after a point cloud completion network completes the first to-be-processed point cloud data and second processed point cloud data after the point cloud completion network completes the second to-be-processed point cloud data; associating the first processed point cloud data and the second processed point cloud data; wherein, the point cloud completion network is acquired, after a pre-training process, by adjusting based on second point cloud data and real point cloud data collected for a real object in a physical space, and the second point cloud data is generated based on neighbor points in first point cloud data of a plurality of real points in the real point cloud data, and the first point cloud data is generated by the pre-trained point cloud completion network based on a latent space vector.

In some embodiments, the game object includes game coins placed into the game area, and the method further includes: based on an association of the first processed point cloud data and the second processed point cloud data, performing at least any one of the following operations: determining the game coins placed by the game participant into the game area; determining an action performed by the game participant on the game object.

In some embodiments, acquiring the first to-be-processed point cloud data corresponding to the game participant in the game area and the second to-be-processed point cloud data corresponding to the game object includes: acquiring raw point cloud data collected by point cloud collecting devices set around the game area; acquiring the first to-be-processed point cloud data of the game participant and the second to-be-processed point cloud data corresponding to the game object by performing point cloud segmentation on the raw point cloud data.

In some embodiments, the point cloud completion network is configured to complete the first to-be-processed point cloud data corresponding to game participants of a plurality of categories and/or the second to-be-processed point cloud data corresponding to game objects of a plurality of categories; or the point cloud completion network includes a third point cloud completion network and a fourth point cloud completion network, and the third point cloud completion network is configured to complete the first to-be-processed point cloud data corresponding to a first category of game participant, and the fourth point cloud completion network is configured to complete the second to-be-processed point cloud data corresponding to a second category of game object.

According to a third aspect of the embodiments of the present disclosure, an apparatus for generating a point cloud completion network is provided, including: an input module, configured to input latent space vector into a pre-trained first point cloud completion network to acquire first point cloud data; a first acquiring module; configured to acquire real point cloud data collected for a real object in a physical space; a selecting module; configured to, for a real point in the real point cloud data, select a preset number of points adjacent to the real point from the first point cloud data as neighbor points of the real point; a generating module, configured to generate second point cloud data based on the neighbor points in the first point cloud data of a plurality of real points; an adjusting module, configured to adjust the first point cloud completion network based on a difference between the second point cloud data and the real point cloud data to acquire a second point cloud completion network.

In some embodiments, the apparatus further includes: a third point cloud acquiring device, configured to acquire third point cloud data; and a completing device, configured to complete the third point cloud data with the second point cloud completion network to acquire fourth point cloud data.

In some embodiments, the apparatus further includes: an raw point cloud acquiring device, configured to acquire raw point cloud data collected by a point cloud collecting device from the physical space; and a point cloud segmentation device, configured to perform point cloud segmentation on the raw point cloud data to acquire the third point cloud data.

In some embodiments, the apparatus further includes: an associating device, configured to associate a plurality of frames of fourth point cloud data.

In some embodiments, the selecting module is configured to: select the preset number of points nearest to the real point from the first point cloud data as the neighbor points of the real point.

In some embodiments, the generating module is configured to take a union of the neighbor points in the first point cloud data of the plurality of real points in the real point cloud data to acquire the second point cloud data.

In some embodiments, the apparatus further includes: a pre-training module, configured to pre-train the first point cloud completion network based on complete point cloud data from a sample point cloud data set.

In some embodiments, the apparatus further includes: a point cloud block acquiring module, configured to acquire a plurality of point cloud blocks in the first point cloud data; a feature determining module, configured to, for each of the plurality of point cloud blocks, determine a points-distribution feature of the point cloud block; a loss function establishing module, configured to establish a loss function based on respective points-distribution feature of the plurality of point cloud blocks; an optimization module, configured to perform an optimization on the trained second point cloud completion network based on the loss function.

In some embodiments, the apparatus further includes: a sampling module, configured to sample a plurality of initial latent space vectors from a latent space; a fourth acquiring module, configured to acquire point cloud data generated by the first point cloud completion network based on each of the initial latent space vectors respectively; a target function determining module, configured to, for each of the initial latent space vectors, determine a target function of the initial latent space vector based on the point cloud data corresponding to the initial latent space vector and the real point cloud data; and a latent space vector determining module, configured to determine the latent space vector from the initial latent space vectors based on the target function of each initial latent space vector.

According to a fourth aspect of the embodiments of the present disclosure, an apparatus for processing point cloud data is provided, including: a second acquiring module, configured to acquire first to-be-processed point cloud data and second to-be-processed point cloud data in a game area, wherein the first to-be-processed point cloud data corresponds to a game participant and the second to-be-processed point cloud data corresponds to a game object; a third acquiring module, configured to configured to acquire first processed point cloud data after a point cloud completion network completes the first to-be-processed point cloud data and second processed point cloud data acquired after the point cloud completion network completes the second to-be-processed point cloud data; an associating module, configured to associate the first processed point cloud data and the second processed point cloud data; wherein, the point cloud completion network is acquired, after a pre-training process, by adjusting based on second point cloud data and real point cloud data collected for a real object in a physical space, and the second point cloud data is generated based on neighbor points in first point cloud data of a plurality of real points in the real point cloud data, and the first point cloud data is generated by the pre-trained point cloud completion network based on a latent space vector.

In some embodiments, the game object includes game coins placed into the game area, and the apparatus further includes: a game coin determining module, configured to, based on an association of the first processed point cloud data and the second processed point cloud data, determine the game coins placed by the game participant into the game area.

In some embodiments, the game object includes game coins placed into the game area, and the apparatus further includes: an action determining module, configured to, determine an action performed by the game participant on the game object.

In some embodiments, the second acquiring module includes: an raw point cloud data acquiring unit, configured to acquire raw point cloud data collected by point cloud collecting devices set around the game area; and a point cloud segmentation unit, configured to perform point cloud segmentation on the raw point cloud data to acquire the first to-be-processed point cloud data of the game participant and the second to-be-processed point cloud data corresponding to the game object.

In some embodiments, the point cloud completion network is configured to complete the first to-be-processed point cloud data corresponding to game participants of a plurality of categories and/or the second to-be-processed point cloud data corresponding to game objects of a plurality of categories; or the point cloud completion network includes a third point cloud completion network and a fourth point cloud completion network, and the third point cloud completion network is configured to complete the first to-be-processed point cloud data corresponding to a first category of game participant, and the fourth point cloud completion network is configured to complete the second to-be-processed point cloud data corresponding to a second category of game object.

According to a fifth aspect of the embodiments of the present disclosure, a system for processing point cloud data is provided, including: a point cloud collecting device set around a game area, for collecting first to-be-processed point cloud data of a game participant and second to-be-processed point cloud data corresponding to a game object in the game area; and a processing unit communicatively connected to the point cloud collecting device, for acquiring first processed point cloud data after a point cloud completion network completes the first to-be-processed point cloud data and second processed point cloud data acquired after the point cloud completion network completes the second to-be-processed point cloud data, and associating the first processed point cloud data and the second processed point cloud data; wherein, the point cloud completion network is acquired, after a pre-training process, by adjusting based on second point cloud data and real point cloud data collected for a real object in a physical space, and the second point cloud data is generated based on neighbor points in first point cloud data of a plurality of real points in the real point cloud data, and the first point cloud data is generated by the pre-trained point cloud completion network based on a latent space vector.

According to a sixth aspect of the embodiments of the present disclosure, a computer readable storage medium storing a computer program is provided, when the computer program is executed by a processor, the method according to any one of above embodiments implemented.

According to a seventh aspect of the embodiments of the present disclosure, a computer device is provided, including a memory, a processor and a computer program stored on the memory and executable on the processor, when the computer program is executed by a processor, the method according to any one of above embodiments implemented.

According to an eighth aspect of the embodiments of the present disclosure, a computer program is provided, including computer-readable codes which, when executed in an electronic device, cause a processor in the electronic device to perform the method according to any one of above embodiments.

In the embodiment of the present disclosure, after a first point cloud completion network is trained, in first point cloud data acquired by the first point cloud completion network based on a latent space vector, neighbor points adjacent to a real point in real point cloud data are selected to generate second point cloud data. Since the process of generating the second point cloud data is based on whether a relative distance between each point in the first point cloud data and the real point in the real point cloud data is close, instead of whether an absolute distance between each point in the first point cloud data and the real point in the real point cloud data is close, the accuracy of generating the second point cloud data can be improved, and the accuracy of the point cloud completion performed by a second point cloud completion network adjusted based on the second point cloud data can be improved.

It should be understood that the above general description and the following detailed description are only exemplary and explanatory, rather than limiting the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the technical solution of the disclosure.

FIG. 1 is a schematic diagram illustrating incomplete point cloud data according to some embodiments.

FIG. 2 is a flowchart illustrating a method of generating a point cloud completion network according to some embodiments of the present disclosure.

FIG. 3 is a schematic diagram illustrating degradation according to some embodiments of the present disclosure.

FIG. 4 is a schematic diagram illustrating a training and optimization process for the point cloud completion network according to some embodiments of the present disclosure.

FIG. 5 is a schematic diagram illustrating a distribution feature of points in the point cloud data according to some embodiments of the present disclosure.

FIG. 6 is a schematic diagram illustrating various candidate complete point cloud data output by the point cloud completion network.

FIG. 7 is a flowchart illustrating a point cloud data processing method according to some embodiments of the present disclosure.

FIG. 8 is a block diagram illustrating an apparatus for generating a point cloud completion network according to some embodiments of the present disclosure.

FIG. 9 is a block diagram illustrating an apparatus for processing point cloud data according to some embodiments of the present disclosure.

FIG. 10 is a schematic diagram illustrating a system for processing point cloud data according to some embodiments of the present disclosure.

FIG. 11 is a schematic structural diagram illustrating a computer device according to some embodiments of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terminology used in the present disclosure is for the purpose of describing particular embodiments only and is not intended to limit the present disclosure. The singular forms ‘a’, ‘said’ and ‘the’ used in the present disclosure and the appended claims are also intended to include the majority of forms unless the context clearly indicates other meanings. It should also be understood that the term ‘and/or’ as used herein refers to and includes any or all possible combinations of one or more associated listed items. In addition, the term ‘at least one’ herein means any combination of at least two of any one or more of a plurality.

It should be understood that although the terms first, second, third, etc. may be employed in this disclosure to describe a variety of information, these information should not be limited to these terms. These terms are only used to distinguish information of the same type from each other. For example, without departing from the scope of the present disclosure, the first information may also be referred to as second information, and similarly, the second information may also be referred to as first information. Depending on the context, the word ‘if’ as used herein may be interpreted as ‘when . . . ’ or ‘upon . . . ’ or ‘in response to a determination’.

In order to make those skilled in the art better understand the technical solutions in the embodiments of the present disclosure, and make the described objects, features and advantages of the embodiments of the present disclosure more apparent, the technical solutions in the embodiments of the present disclosure will be further described in detail below with reference to the accompanying drawings.

In practical applications, point cloud data is always required to be collected and performed with some processing. For example, in the field of autonomous driving, a LiDAR may be installed on autonomous vehicles, and the LiDAR may be used to collect point cloud data around the vehicle and analyze the point cloud data to determine moving speed of obstacles around the vehicle, so to perform a route planning for the vehicles effectively. For another example, in the field of robot navigation, point cloud data of the surrounding environment of the robot can be collected, and the robot can be positioned based on various objects identified from the point cloud data. For another example, in some game scenarios, point cloud data in a game area can be collected, and various targets (for example, game participants and game objects) identified from the point cloud data can be associated.

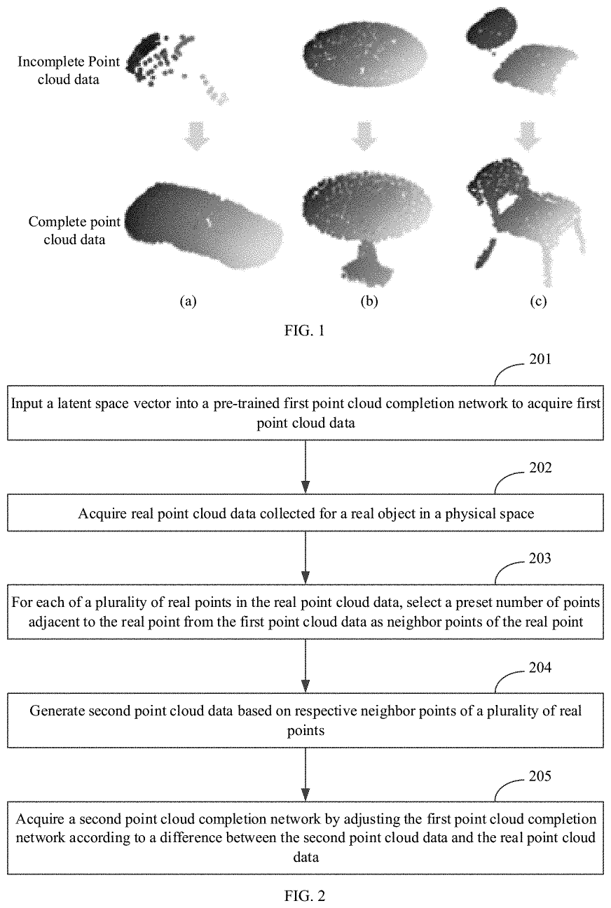

However, in actual scenarios, due to occlusion and other reasons, the collected 3D point cloud is always not complete point cloud data, but incomplete point cloud data. For example, for a 3D object, the surface facing away from the point cloud collecting device may be occluded by the surface facing the point cloud collecting device, resulting in the point cloud facing away from the point cloud collecting device cannot be collected. Even if it is a flat object, because there are always multiple overlapping objects in a scenario, the surface of one object may be occluded by the surface of another object, resulting in incompletion of the collected point cloud data. In addition, there are many other reasons for the generation of the incomplete point cloud, and the collected forms of the incomplete point cloud are also diverse. FIG. 1 is a schematic diagram illustrating a incomplete cloud collected in a physical space and a corresponding complete point cloud according to some embodiments.

It should be noted that the incomplete cloud data in the present disclosure refers to point cloud data that cannot represent the complete shape of the object. For example, when an object includes one or more surfaces, a part of the surfaces or a partial area of one surface may be occluded, and the collected point cloud data does not include the points of the occluded surface or area, so that the collected point cloud data cannot represent the corresponding shape of the occluded surface or area. The surfaces face different directions, or there is a sudden change in direction between each other. Correspondingly, the complete point cloud data refers to point cloud data that can represent the complete shape of the object. For example, in a case where an object includes one or more surfaces, the point cloud data includes points on each surface, so that the point cloud data can completely represent the shape of each surface.

Operations based on the incomplete point cloud are difficult to achieve expected results. Therefore, it is necessary to perform point cloud completion on the incomplete point cloud data to acquire the complete point cloud data corresponding to the incomplete point cloud data. In related art, the point cloud completion network is trained based on complete point cloud data from a sample data set, so that the point cloud collection network can learn better prior information of spatial geometry based on the complete point cloud data. The trained point cloud completion network outputs the complete point cloud data based on the latent space vector, and perform an optimization on the trained point cloud completion network based on the point cloud data acquired from the degradation process on the output complete point cloud data and the real point cloud data collected from the physical space, so as to acquire the point cloud completion network in an unsupervised way.

The degradation process refers to the conversion of the complete point cloud data output by the trained point cloud completion network into the incomplete point cloud data corresponding to the real point cloud data, that is, the determination of points in the output complete point cloud data corresponding to the real point cloud data. Since the point cloud data is disordered and unstructured, the conversion method in related art divides the physical space into multiple voxels, and the size of each voxel is preset. If a certain voxel includes points in the real point cloud data, all points of the complete point cloud data in the voxel are determined as points in the incomplete point cloud data corresponding to the real point cloud data. However, this conversion method is more sensitive to the size of the voxel. When the voxel size is too large, the points in the converted incomplete cloud data and the real point cloud data are quite different, that is, the conversion accuracy is low. There is currently no better way to accurately determine the size of a voxel.

Therefore, the present disclosure provides a method of generating a point cloud completion network. As shown in FIG. 2, the method includes:

At step 201, a latent space vector is input into a pre-trained first point cloud completion network to acquire first point cloud data.

At step 202, real point cloud data collected for a real object in a physical space is acquired.

At step 203, for each of a plurality of real points in the real point cloud data, a preset number of points adjacent to the real point are selected from the first point cloud data as neighbor points of the real point.

At step 204, second point cloud data is generated based on respective neighbor points of a plurality of the real points in the first point cloud data.

At step 205, the first point cloud completion network is adjusted according to a difference between the second point cloud data and the real point cloud data to acquire a second point cloud completion network.

In the embodiment of the present disclosure, after a first point cloud completion network is trained, in first point cloud data acquired by the first point cloud completion network based on the latent space vector, neighbor points adjacent to a real point in the real point cloud data are selected for generating the second point cloud data. The real point cloud data may be the point cloud data acquired by a point cloud collecting device performing three-dimensional scanning on the real object. Due to the influence of at least one factor of occlusion and the point sampling accuracy of the point cloud collecting device, the real point cloud data is usually incomplete point cloud data. Since the process of generating the second point cloud data is based on whether a relative distance between each point in the first point cloud data and the real point in the real point cloud data is close, instead of an absolute distance between each point in the first point cloud data and the real point in the real point cloud data is close, the difficulty of accurately setting a voxel size when using voxels to determine the corresponding points in the two point cloud data can be avoided. Therefore, the accuracy of generating the second point cloud data can be improved and the accuracy of point cloud completion performed by the second point cloud completion network adjusted based on the second point cloud data can be further improved.

In step 201, the second point cloud completion network may be, for example, a generator in any type of generative adversarial networks (GAN) such as tree-GAN or r-GAN. The first point cloud completion network can be trained by only using complete point cloud data as training data, without collecting a point cloud pair composed of complete point cloud data and incomplete cloud data as training data. Since it is difficult to collect complete point cloud data in real scenarios, the complete point cloud data used as training data in the present disclosure may be artificially generated, for example, the complete point cloud data may be from a sample data set such as ShapeNet. Through training, the first point cloud completion network can learn better prior information of spatial geometry based on the complete point cloud data.

An optimal initial latent space vector can be selected from a plurality of initial latent space vectors as the latent space vector (referred to as the target latent space vector). The plurality of initial latent space vectors may be acquired by sampling from the latent space, and the sampling method may be random sampling. In some embodiments, the latent space may be a 96-dimensional space, and a 96-dimensional vector can be randomly generated for each sampling, that is, the initial latent space vector. For each initial latent space vector, the point cloud data generated by the first point cloud completion network based on the initial latent space vector can be acquired, the target function of the initial latent space vector can be determined based on the point cloud data corresponding to the initial latent space vector and the real point cloud data. Then, based on the target function of each initial latent space vector, the target latent space vector is determined from each of the initial latent space vectors. Through the above method, an optimal target latent space vector can be selected from a plurality of initial latent space vectors so to use in an optimization process for the point cloud completion network, which can increase the optimization speed of the point cloud completion network and improve the optimization efficiency.

The distance between the point cloud data corresponding to the initial latent space vector and the real point cloud data may be used as the target function. In some embodiments, a chamfer distance and a feature distance between the incomplete point cloud corresponding to the initial latent space vectors and the real point cloud data can be determined, and a sum of the chamfer distance and the feature distance is determined as the target function. The chamfer distance and the feature distance are as follows:

$$\begin{matrix}{L}_{C D} ( {x}_{p} , {x}_{in} ) = \frac{1}{\vert {x}_{p} \vert} {\sum }_{p ∈ {x}_{p}} {min}_{q ∈ {x}_{i n}} {‖ p - q ‖}_{2}^{2} + \frac{1}{\vert {x}_{i n} \vert} {\sum }_{q ∈ {x}_{i n}} {min}_{p ∈ {x}_{p}} {‖ p - q ‖}_{2}^{2} ; \\ {L}_{F D} = {‖ D ( {x}_{p} ) - D ( {x}_{i n} ) ‖}_{1} ;\end{matrix}$$

where L_{CD} and L_{FD} represents the chamfer distance and the feature distance respectively, and xₚ represents the point cloud data acquired by degrading the point cloud data corresponding to the initial latent space vector, xᵢₙ represents the real point cloud data, P and q represents points in xₚ and points in xᵢₙ respectively, ∥⋅∥₁ and ∥⋅∥₂ represents norm 1 and norm 2 respectively, D(xₚ) and D(xᵢₙ) represents the feature vector of xₚ and xᵢₙ respectively. The above is only an example of the target function. In addition to the target function described above, other types of target function can also be used according to actual requirements, which will not be repeated here.

After acquiring the target function corresponding to each initial latent space vector, the initial latent space vector with the smallest target function may be determined as the target latent space vector. Then, the target function corresponding to the target latent space vector is acquired, and an optimization is performed on the network parameters of the point cloud completion network based on the target function corresponding to the target latent space vector. The optimization method includes, but is not limited to, the gradient descent method. In the optimization process, the optimization can be performed on the target latent space vector and the network parameters of the first point cloud completion network at the same time to minimize the target function corresponding to the target latent space vector, thereby acquiring the second point cloud completion network.

In step 202, the real point cloud data may be collected by a point cloud collecting device (for example, a LiDAR, a depth camera, etc.) set in the physical space. The real object may be any type of object, for example, person, animal, plant, table, chair, vehicle, furniture, and so on. In some embodiments, there may be multiple point cloud collecting devices, and the real point cloud data can be acquired by fusing the point cloud data collected by the multiple point cloud collecting devices. In other embodiments, the raw point cloud data collected by the point cloud collecting device may include point cloud data of multiple real objects. Therefore, point cloud segmentation may be performed on the raw point cloud data to acquire the real point cloud data.

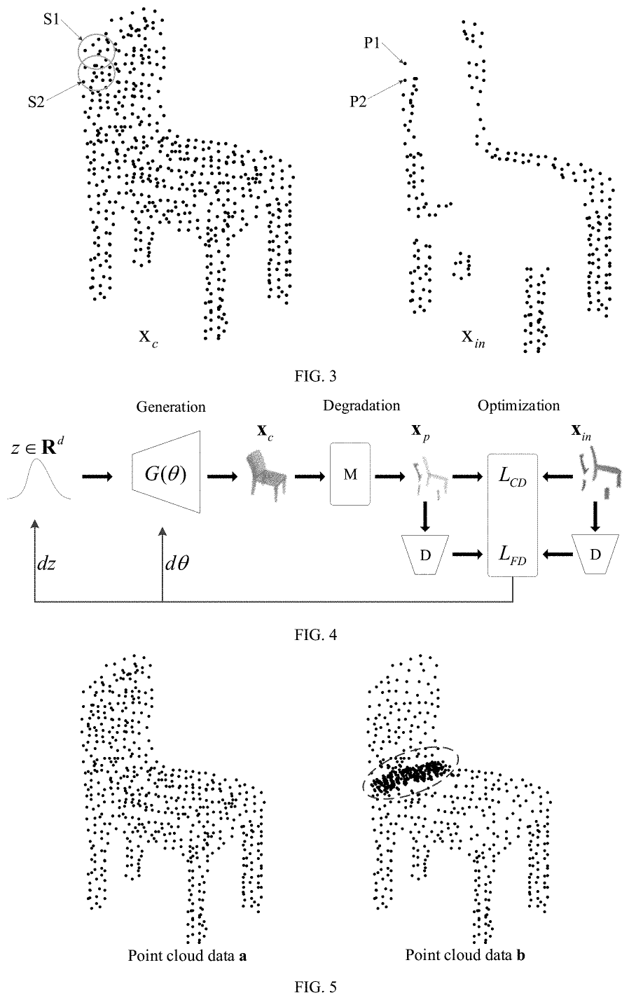

In step 203, a point in the first point cloud data corresponding to the real point in the real point cloud data can be acquired. As shown in FIG. 3, for a real point P1 in the real point cloud data xin, neighbor points of P1 in the first point cloud data xc may be acquired, the neighbor points may include k points nearest to P1 in xc, which are the points shown in area S1. In the same way, the respective neighbor points in the first point cloud data xc of a real point P2 in the real point cloud data xin can be acquired, which are the points shown in area S2. In the same way, neighbor points in the first point cloud data xc of other real points in the real point cloud data xin can be acquired, the real points may include some of all of the points in the real point cloud data xin. Optionally, the real points include 1/k points in the real point cloud data xin, so that the number of points in the first point cloud data after the degradation process does not exceed the number of points in the real point cloud data, where k can be an integer greater than or equal to 1. When k is greater than 1, since there are multiple neighbor points at each time, the robustness of the generated second point cloud data can be improved.

In step 204, since the neighbor points of each real point in the first point cloud data may partially overlap, a union of the respective neighbor points of the multiple real points in the real point cloud data can be taken, to acquire the second point cloud data.

In step 205, an optimization can be performed on the target latent space vector and the network parameters of the point cloud completion network at the same time, so as to minimize the target function corresponding to the target latent space vector. The training and optimization process of the point cloud completion network is shown in FIG. 4, using a generative adversarial network (GAN) as the point cloud completion network. The GAN includes a generator G and a discriminator D. The two D shown in the figure can be the same discriminator. The feature distance can be calculated based on the features output by an intermediate layer of the discriminator D in the trained GAN. In a pre-training stage, multiple initial latent space vectors are collected randomly from the latent space Rd and input to generator G to acquire the complete point cloud data corresponding to each initial latent space vector, that is, the first point cloud data xc, and the xc is degraded to incomplete point cloud data xp, that is the second point cloud data. For each second point cloud data xp, based on the second point cloud data xp and the real point cloud data xin sampled in the physical space, the target function is acquired, so that the optimal target latent space vector z is acquired. Using the gradient descent method to perform the optimization on the target latent space vector z and the parameter θ of the generator, the target function corresponding to the target latent space vector can be minimized, so as to acquire the second point cloud completion network. The second point cloud completion network acquired by the above method does not need to use the incomplete cloud data as training data during the training process, and can be applied to the completion of various forms of incomplete point clouds with good generalization performance.

In some embodiments, the distribution of points in the point cloud data is not even, that is, the distribution of points in the point cloud data is dense in some areas, and scattered in other areas. FIG. 5 is a comparison diagram of evenly distributed point cloud data a and unevenly distributed point cloud data b. It can be seen that in point cloud data b, most of the collected points are distributed in the dotted box, while the distribution of points in other regions is more scattered. Since the number of points that the point cloud completion network can handle is relatively fixed, the unevenness of the point cloud data means that the number of points in some areas may not be enough for the point cloud completion network to acquire enough information for point cloud completion, which causes the inaccuracy of the result of point cloud completion. Therefore, in order to solve the above problem, in the training and optimization process of the point cloud completion network, the optimization can be performed on the network parameters of the point cloud completion network, so that the distribution of points in the point cloud data acquired by the point cloud completion network performing the point cloud completion is more even.

In the training and optimization stage of the point cloud completion network, point cloud data C output by the point cloud completion network based on the latent vector can be acquired, and the distribution feature of the points in the point cloud data C can be acquired. A loss function is established based on the distribution feature of the points in the point cloud data C, and the optimization is performed on the point cloud completion network based on the loss function.

N seed positions can be randomly sampled from the point cloud data C. For example, the sampling method may be the farthest point sampling (FPS), so that the distance between each seed position is the farthest. The distribution feature of the points in a point cloud block may be determined based on the average distance between each point in the point cloud block and a certain position (for example, a seed position) in the point cloud block. The loss function can be written as:

$${L}_{patch} = Var ( {\{ {ρ}_{j} \}}_{j = 1}^{n} ) , {ρ}_{j} = \frac{1}{k} {\sum }_{i = 1}^{k} {dist}_{ij}^{2} ;$$

where L_{patch} is the loss function, Var represents the variance, ρⱼ is the average distance of the points in the j-th point cloud block, n is the total number of point cloud blocks, k is the total number of points in the point cloud block, distᵢⱼ is the distance between the i-th point in the j-th point cloud block and the seed position. The network parameters of the point cloud completion network can be adjusted to minimize the variance of the average distance corresponding to each point cloud block in the point cloud data C output by the point cloud completion network. In this way, the distance between different points in each point cloud block and the seed point can be closer, thereby improving the evenness of the point cloud data output by the point cloud completion network.

The network optimization process based on the above loss function can be performed synchronously with the process of adjusting the first point cloud completion network based on the second point cloud data and the real point cloud data, or can be performed in any order, which is not limited in the present disclosure.

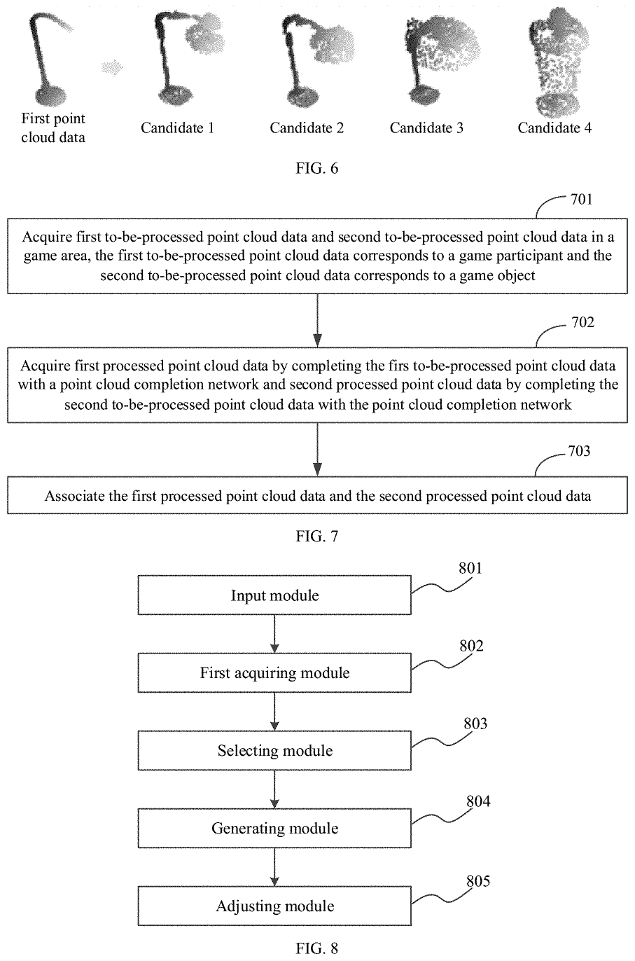

After acquiring the second point cloud completion network, a third point cloud data can be acquired, and the third point cloud data can be completed by using the second point cloud completion network, so as to acquire fourth point cloud data. For each input third point cloud data, the second point cloud completion network can output one or more candidate complete point cloud data. FIG. 6 is a schematic diagram of the third point cloud data and corresponding candidate complete point cloud data of some embodiments. Based on the third point cloud data, the second point cloud completion network has output a total of 4 candidate complete point cloud data for selection. Further, a selection instruction for each candidate complete point cloud data can be acquired, and in response to the selection instruction, one of the candidate complete point cloud data is selected as the fourth point cloud data.

The present disclosure can be used in any scene equipped with a 3D sensor (such as a depth camera or a LiDAR), and the incomplete cloud data of the entire scene can be scanned by the 3D sensor. The incomplete cloud data of each object in the scene generates complete point cloud data through the second point cloud completion network, and then a 3D reconstruction of the entire scene can be performed. The reconstructed scene can provide accurate spatial information, such as detecting the distance between a human body and other objects in the scene, and the distance between people. The spatial information can be used to associate people with objects, and associate people with people, so as to improve the accuracy of the association.

In some embodiments, multiple frames of fourth point cloud data can be acquired, and multiple frames of fourth point cloud data can be associated. The multiple frames of fourth point cloud data may be fourth point cloud data of objects of a same category. For example, in a game scene, each frame of fourth point cloud data may be point cloud data corresponding to a game participant. By associating the point cloud data corresponding to multiple game participants, each game participant participating in a same game in a same game area can be determined. The multiple frames of fourth point cloud data may also be fourth point cloud data of objects of different categories. Still taking a game scene as an example, the multiple frames of fourth point cloud data may include point cloud data corresponding to game participants and point cloud data corresponding to the game objects. By associating the point cloud data corresponding to a game participant with the point cloud data corresponding to a game object, the relationship between the game participant and the game object can be determined, for example, game coins, game cards, cash belonging to the game participant; the game area where the game participant is located; and the seat where the game participant sits, etc.

The position and state of game participants and game objects in the game scene may change in real time. The relationship between game participants, the relationship between game participants and game objects may also change in real time, and these real-time changing information is of great significance for the analysis of the game state and the monitoring of the game progress. The incomplete cloud data of game participants and/or game objects collected by the point cloud collecting device is completed, which is beneficial to improve the accuracy of the association between the point cloud data and further improve the reliability of the result of game state analysis and game progress monitoring based on the association.

In some embodiments, after the fourth point cloud data is acquired, an object included in the fourth point cloud data may be identified, so as to determine the category of the object. The association process can also be performed on the multiple frames of fourth point cloud data based on the identification result. Further, in order to improve the accuracy of the association process and/or object identification, the fourth point cloud data may be homogenized before the association process and/or object identification are performed.

In some embodiments, as shown in FIG. 7, a method of processing point cloud data is also provided. The method includes:

At step 701, first to-be-processed point cloud data and second to-be-processed point cloud data in a game area is acquired, where the first to-be-processed point cloud data corresponds to a game participant and the second to-be-processed point cloud data corresponds to a game object;.

At step 702, first processed point cloud data after a point cloud completion network completes the first to-be-processed point cloud data and second processed point cloud data after the point cloud completion network completes the second to-be-processed point cloud data is acquired.

At step 703, the first processed point cloud data and the second processed point cloud data is associated.

The point cloud completion network is acquired, after a pre-training process, by adjusting based on second point cloud data and real point cloud data collected for a real object in a physical space, and the second point cloud data is generated based on neighbor points in first point cloud data of a plurality of real points in the real point cloud data, and the first point cloud data is generated by the pre-trained point cloud completion network based on a latent space vector.

The game participants may include, but is not limited to, at least one of a game referee, a game player, and a game audience.

In some embodiments, the game object includes gaming chips placed in the game area; the method further includes: determining the gaming chips placed by the game participant into the game area based on an association of the first processed point cloud data and the second processed point cloud data. Each game participant can have a certain number of game coins for playing the game. By associating the game participant with the game coins, the number of chips that the game participant placed into the game can be determined, the number of chips that the game participants have and placed into different stages of the game, and whether the operations in the game process comply with the pre-set rules of the game can be determined.

In some embodiments, the method further includes: determining an action performed by the game participant on the game object based on the association of the first processed point cloud data and the second processed point cloud data. The action may include sitting, placing chips, dealing cards, and so on.

In some embodiments, acquiring the first to-be-processed point cloud data of game participant and the second to-be-processed point cloud data corresponding to the game object in the game area includes: acquiring raw point cloud data collected by the point cloud collecting devices set around the game area; performing point cloud segmentation on the raw point cloud data to acquire the first to-be-processed point cloud data of the game participant and the second to-be-processed point cloud data corresponding to the game object.

In some embodiments, the point cloud completion network is configured to complete the first to-be-processed point cloud data corresponding to game participants of a plurality of categories and/or the second to-be-processed point cloud data corresponding to game objects of a plurality of categories. In this case, the plurality of categories of the complete point cloud data can be used to train the point cloud completion network, and the plurality of categories of point cloud data of real objects can be used to perform optimization on the trained point cloud completion network in a network optimization stage.

Alternatively, the point cloud completion network includes a third point cloud completion network and a fourth point cloud completion network, and the third point cloud completion network is configured to complete the first to-be-processed point cloud data corresponding to a first category of game participant, and the fourth point cloud completion network is configured to complete the second to-be-processed point cloud data corresponding to a second category of game object. In this case, different categories of complete point cloud data can be used to train different point cloud completion networks, and an optimization is performed on each trained point cloud completion network based on the point cloud data of the corresponding category of real object.

The point cloud completion network used in the embodiments of the present disclosure can be acquired based on the foregoing method of generating a point cloud completion network. For details, please refer to the foregoing embodiment of the method of generating a point cloud completion network, which will not be repeated here.

A person skilled in the art may understand that, in the described method of the specific implementation, the drafting order of each step does not imply that the strictly executed order forms any limitation to the implementation process, and the specific execution order of each step should be determined by its function and possibly intrinsic logic.

As shown in FIG. 8, the present disclosure also provides an apparatus for generating a point cloud completion network, including:

an input module 801, configured to input latent space vector into a pre-trained first point cloud completion network to acquire first point cloud data;

a first acquiring module 802; configured to acquire real point cloud data collected for a real object in a physical space;

a selecting module 803; configured to, for each of a plurality of real points in the real point cloud data, select a preset number of points adjacent to the real point from the first point cloud data as neighbor points of the real point;

a generating module 804, configured to generate second point cloud data based on the respective neighbor points of a plurality of the real points;

an adjusting module 805, configured to adjust the first point cloud completion network based on a difference between the second point cloud data and the real point cloud data to acquire a second point cloud completion network.

In some embodiments, the apparatus further includes: a third point cloud acquiring device, configured to acquire third point cloud data; and a completing device, configured to complete the third point cloud data with the second point cloud completion network to acquire fourth point cloud data.

In some embodiments, the apparatus further includes: an raw point cloud acquiring device, configured to acquire raw point cloud data collected by a point cloud collecting device from the physical space; and a point cloud segmentation device, configured to perform point cloud segmentation on the raw point cloud data to acquire the third point cloud data.

In some embodiments, the apparatus further includes: an associating device, configured to associate a plurality of frames of fourth point cloud data.

In some embodiments, the associating device includes: an acquiring unit, configured to acquire a plurality of point cloud blocks in the first point cloud data; for each of the plurality of point cloud blocks, determine a points-distribution feature in the point cloud block; an adjusting unit, configured to adjust the position of the points in each point cloud block in the fourth point cloud data based on the points-distribution feature in the point cloud block; and an associating unit, configured to associate the adjusted plurality of frames of the fourth point cloud data

In some embodiments, the generating module is configured to take a union of the neighbor points in the first point cloud data of the plurality of real points in the real point cloud data to acquire the second point cloud data.

In some embodiments, the apparatus further includes: a pre-training module, configured to pre-train the first point cloud completion network based on complete point cloud data from a sample point cloud data set.

In some embodiments, the apparatus further includes: a sampling module, configured to sample a plurality of initial latent space vectors from a latent space; a fourth acquiring module, configured to acquire point cloud data generated by the first point cloud completion network based on each of the initial latent space vectors respectively; a target function determining module, configured to, for each of the initial latent space vectors, determine a target function of the initial latent space vector based on the point cloud data corresponding to the initial latent space vector and the real point cloud data; and a latent space vector determining module, configured to determine the latent space vector from the initial latent space vectors based on the target function of each initial latent space vector.

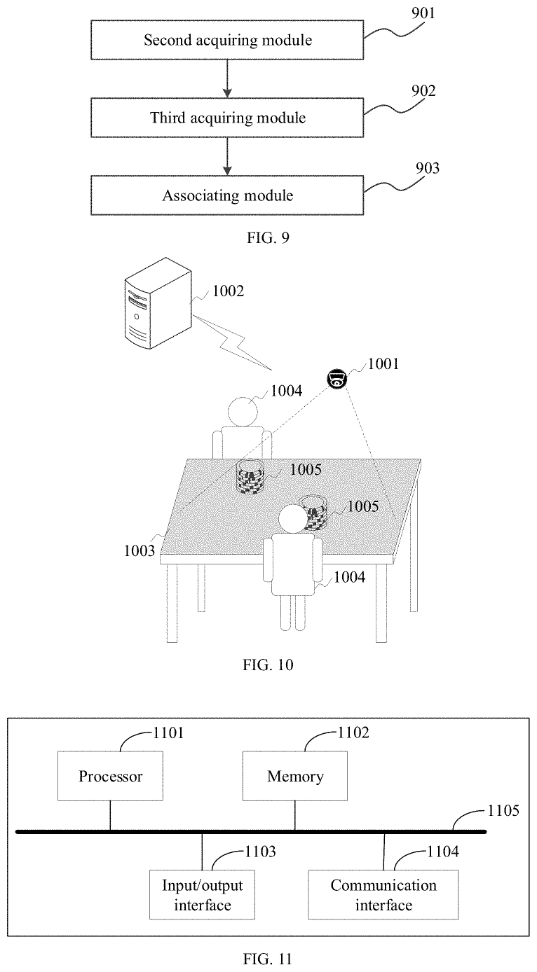

As shown in FIG. 9, the present disclosure also provides an apparatus for processing point cloud data, including:

a second acquiring module 901, configured to acquire first to-be-processed point cloud data and second to-be-processed point cloud data in a game area, wherein the first to-be-processed point cloud data corresponds to a game participant and the second to-be-processed point cloud data corresponds to a game object;

a third acquiring module 902, configured to acquire first processed point cloud data after a point cloud completion network completes the first to-be-processed point cloud data and second processed point cloud data acquired after the point cloud completion network completes the second to-be-processed point cloud data;

an associating module 903, configured to associate the first processed point cloud data and the second processed point cloud data;

wherein, the point cloud completion network is acquired, after a pre-training process, by adjusting based on second point cloud data and real point cloud data collected for a real object in a physical space, and the second point cloud data is generated based on neighbor points in first point cloud data of a plurality of real points in the real point cloud data, and the first point cloud data is generated by the pre-trained point cloud completion network based on a latent space vector.

In some embodiments, the game object includes game coins placed into the game area, and the apparatus further includes: a game coins determining module, configured to, based on an association of the first processed point cloud data and the second processed point cloud data, determine the game coins placed in the game area by the game participant.

In some embodiments, the game object includes game coins placed into the game area, and the apparatus further includes: an action determining module, configured to, determine an action performed by the game participant on the game object.

In some embodiments, the second acquiring module includes: an raw point cloud data acquiring unit, configured to acquire raw point cloud data collected by point cloud collecting devices set around the game area; and a point cloud segmentation unit, configured to perform point cloud segmentation on the raw point cloud data to acquire the first to-be-processed point cloud data of the game participant and the second to-be-processed point cloud data corresponding to the game object.

In some embodiments, the point cloud completion network is configured to complete the first to-be-processed point cloud data corresponding to game participants of a plurality of categories and/or the second to-be-processed point cloud data corresponding to game objects of a plurality of categories; or the point cloud completion network includes a third point cloud completion network and a fourth point cloud completion network, and the third point cloud completion network is configured to complete the first to-be-processed point cloud data corresponding to a first category of game participant, and the fourth point cloud completion network is configured to complete the second to-be-processed point cloud data corresponding to a second category of game object.

In some embodiments, the functions or modules contained in the apparatuses provided in the embodiments of the present disclosure can be used to execute the methods described in the above method embodiments. For specific implementation, refer to the description of the above method embodiments. For brevity, here No longer.

As shown in FIG. 10, the present disclosure also provides a system for processing point cloud data. The system includes a point cloud collecting device 1001 set around a game area 1003; and a processing unit 1002 communicatively connected to the point cloud collecting device 1001.

The point cloud collecting device 1001 can collect the first to-be-processed point cloud data of the game participant 1004 and the second to-be-processed point cloud data corresponding to the game object 1005 in the game area 1003, and the processing unit 1002 can acquire first processed point cloud data after a point cloud completion network completes the first to-be-processed point cloud data and second processed point cloud data acquired after the point cloud completion network completes the second to-be-processed point cloud data, and associate the first processed point cloud data and the second processed point cloud data.

The point cloud collecting device 1001 can collect the to-be-processed point cloud data of a target object in the game area; the target object includes at least one of a game participant and a game object. The processing unit 1002 can acquire the processed point cloud data after the point cloud completion network completes the to-be-processed point cloud data, and identify the processed point cloud data.

The point cloud completion network is acquired, after a pre-training process, by adjusting based on second point cloud data and real point cloud data collected for a real object in a physical space, and the second point cloud data is generated based on neighbor points in first point cloud data of a plurality of real points in the real point cloud data, and the first point cloud data is generated by the pre-trained point cloud completion network based on a latent space vector.

The point cloud completion network used in the embodiments of the present disclosure can be the second point cloud completion network generated by the method of generating a point cloud completion network. For details, please refer to the foregoing embodiment of the method of generating a point cloud completion network, which will not be repeated here.

In some embodiments, the point cloud collecting device 1001 may be a LiDAR or a depth camera. One or more point cloud collecting devices 1001 can be set around the game area. Different point cloud collecting devices 1001 can collect point cloud data of different sub-areas in the game area, and the sub-areas collected by different point cloud collecting devices 1001 can be overlapped.

The number of game participants in the game area may be one or more, and each game participant may correspond to one or more game objects, including but not limited to game coins, cash, seats, chess and cards, logo props and game table, etc. By identifying the processed point cloud data, the categories of objects included in different point cloud data can be determined, and the spatial information where the objects of each category are located can also be determined. By associating the first processed point cloud data with the second processed point cloud data, the relationship between various game objects and game participants can be acquired, and the actions performed by the game participants can also be determined, and whether the operations in the game process comply with the pre-set rules of the game can be determined.

The embodiments of this specification also provide a computer device, which includes at least a memory, a processor, and a computer program stored on the memory and executable on the processor, when the computer program is executed by a processor, the method according to any of the above embodiments can be implemented.

FIG. 11 shows a more specific hardware structure diagram of a computing device provided by an embodiment of the present description, and the device may include a processor 1101, a memory 1102, an input/output interface 1103, a communication interface 1104, and a bus 1105. The processor 1101, the memory 1102, the input/output interface 1103, and the communication interface 1104 implement a communication connection between each other inside the device through the bus 1105.

The processor 1101 may be implemented by using a common central processing unit (CPU), a microprocessor, an Application specific integrated circuit (ASIC), or one or more integrated circuits, etc., for executing relevant programs to implement the technical solutions provided by the embodiments of the present description. The processor 1101 may also include a graphics card, and the graphics card may be an Nvidia titan X graphics card or a 1080Ti graphics card.

The memory 1102 may be implemented in the form of a read only memory (ROM), a random access memory (RAM), a static storage device, a dynamic storage device, and the like. The memory 1102 may store an operating system and other application programs. When the technical solutions provided in the embodiments of the present specification are implemented through software or firmware, related program codes are stored in the memory 1102 and are invoked and executed by the processor 1101.

The input/output interface 1103 is used to connect an input/output module to realize information input and output. The input/output/module can be configured in the device as a component (not shown in the figure), or it can be connected to the device to provide corresponding functions. The input device may include a keyboard, a mouse, a touch screen, a microphone, various sensors, etc., and an output device may include a display, a speaker, a vibrator, an indicator light, and the like.

The communication interface 1104 is used to connect a communication module (not shown in the figure) to implement communication interaction between the device and other devices. The communication module can realize communication through wired means (such as USB, network cable, etc.), or through wireless means (such as mobile network, WIFI, Bluetooth, etc.).

The bus 1105 includes a path to transmit information between various components of the device (for example, the processor 1101, the memory 1102, the input/output interface 1103, and the communication interface 1104).

It should be noted that although the above device only shows the processor 1101, the memory 1102, the input/output interface 1103, the communication interface 1104, and the bus 1105, in the specific implementation process, the device may also include other necessary components for normal operation. In addition, those skilled in the art can understand that the above-mentioned device may also include only the components necessary to implement the solutions of the embodiments of the present specification, and not necessarily include all the components shown in the figures.

Embodiments of the present disclosure further provides a computer readable storage medium having a computer program stored thereon, where the program is executed by a processor to perform steps in the method according to any of the embodiments as described above.

Embodiments of the present disclosure also provide a computer program, including computer-readable codes which, when executed in an electronic device, cause a processor in the electronic device to perform steps in the method according to any of the embodiments as described above.

The computer readable medium includes permanent and non-permanent, removable and non-removable medium, and information storage can be realized by any method or technology. The information can be computer readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM, digital versatile disc (DVD) or other optical storage, magnetic cassettes, magnetic tape storage or other magnetic storage devices or any other non-transmission media can be used to store information that can be accessed by computing devices. According to the definition in this article, the computer readable medium does not include transitory medium, such as modulated data signals and carrier waves.

From the description of the above implementation manners, it can be known that those skilled in the art can clearly understand that the embodiments of this specification can be implemented by means of software plus a necessary general hardware platform. Based on such understanding, the technical solutions of the embodiments of the present description essentially or the part contributing to the prior art may be embodied in the form of a software product. The computer software product may be stored in a storage medium. For example, a ROM/RAM, a magnetic disk, an optical disk, and the like include several instructions for enabling a computer device (which may be a personal computer. The server, or the network device, etc.) executes the method described in each embodiment or some part of the embodiment of the present description.

The systems, apparatuses, modules, or units explained in the above embodiments may be implemented by computer chips or entities, or implemented by products with certain functions. A typical implementation apparatus is a computer, and a specific form of the computer may be a personal computer, a laptop computer, a cellular phone, a camera phone, a smart phone, a personal digital assistant, a media player, a navigation device, an e-mail transceiver device, a game console, a tablet computer, a wearable device, or a combination of any of these devices.

Various embodiments in the present description are described in a progressive manner, and parts similar to each other may be referred to for each other, and the description of each embodiment is different from the other embodiments. Especially, for apparatus embodiments, since the apparatuses are basically similar to method embodiments, the description is simplified, and reference may be made to some of the description of the method embodiment. The apparatus embodiments described above are merely schematic, in which the modules described as separate components may or may not be physically separated, and the functions of the modules may be implemented in one or more software and/or hardware when the embodiments of the present description are implemented. Part or all of the modules a memory be selected according to actual requirements to implement the objectives of the solutions in the embodiments. Those of ordinary skill in the art can understand and implement without creative work.

1. A method of generating a point cloud completion network, comprising:
acquiring first point cloud data by inputting a latent space vector into a pre-trained first point cloud completion network;
acquiring real point cloud data which is collected for a real object in a physical space;
for each of a plurality of real points in the real point cloud data, selecting a preset number of points adjacent to the real point from the first point cloud data as neighbor points of the real point;
generating second point cloud data based on respective neighbor points of the plurality of real points;
acquiring a second point cloud completion network by adjusting the first point cloud completion network based on a difference between the second point cloud data and the real point cloud data.

2. The method of claim 1, further comprising:
acquiring third point cloud data;
acquiring fourth point cloud data by completing the third point cloud data with the second point cloud completion network.

3. The method of claim 2, further comprising:
acquiring raw point cloud data collected by a point cloud collecting device from the physical space;
acquiring the third point cloud data by performing point cloud segmentation on the raw point cloud data.

4. The method of claim 2, further comprising:
associating a plurality of frames of the fourth point cloud data.

5. The method of any of claim 1, wherein selecting a preset number of points adjacent to the real point from the first point cloud data as neighbor points of the real point comprises:
selecting the preset number of points nearest to the real point from the first point cloud data as the neighbor points of the real point.

6. The method of claim 1, wherein generating the second point cloud data based on respective neighbor points of the plurality of real points comprises:
acquiring the second point cloud data by taking a union of the respective neighbor points of the plurality of real points in the real point cloud data.

7. The method of claim 1, further comprising:
pre-training the first point cloud completion network based on complete point cloud data from a sample point cloud data set.

8. The method of claim 7, further comprising:
acquiring a plurality of point cloud blocks in the first point cloud data;
for each of the plurality of point cloud blocks, determining a points-distribution feature of the point cloud block;
establishing a loss function based on respective points-distribution feature of the plurality of point cloud blocks;
performing an optimization on the trained second point cloud completion network based on the loss function.

9. The method claim 1, wherein the latent space vector is acquired based on the following method:
sampling a plurality of initial latent space vectors from a latent space;
for each of the initial latent space vectors,
acquiring point cloud data generated by the first point cloud completion network based on the initial latent space vector;
determining a target function of the initial latent space vector based on the point cloud data corresponding to the initial latent space vector and the real point cloud data;
determining the latent space vector from the initial latent space vectors based on respective target functions of the initial latent space vectors.

10. A method of processing point cloud data, comprising:
acquiring first to-be-processed point cloud data and second to-be-processed point cloud data in a game area, wherein the first to-be-processed point cloud data corresponds to a game participant and the second to-be-processed point cloud data corresponds to a game object;
acquiring first processed point cloud data after a point cloud completion network completes the first to-be-processed point cloud data and second processed point cloud data after the point cloud completion network completes the second to-be-processed point cloud data;
associating the first processed point cloud data and the second processed point cloud data;
wherein, the point cloud completion network is acquired, after a pre-training process, by adjusting based on second point cloud data and real point cloud data collected for a real object in a physical space, and the second point cloud data is generated based on neighbor points in first point cloud data of a plurality of real points in the real point cloud data, and the first point cloud data is generated by the pre-trained point cloud completion network based on a latent space vector.

11. The method of claim 10, wherein the game object comprises game coins placed into the game area, and the method further comprises:
based on an association of the first processed point cloud data and the second processed point cloud data, performing at least any one of the following operations:
determining the game coins placed by the game participant into the game area;
determining an action performed by the game participant on the game object.

12. The method of claim 10, wherein acquiring the first to-be-processed point cloud data corresponding to the game participant in the game area and the second to-be-processed point cloud data corresponding to the game object comprises:
acquiring raw point cloud data collected by point cloud collecting devices set around the game area;
acquiring the first to-be-processed point cloud data of the game participant and the second to-be-processed point cloud data corresponding to the game object by performing point cloud segmentation on the raw point cloud data.

13. The method of claim 10, wherein the point cloud completion network is configured to complete the first to-be-processed point cloud data corresponding to game participants of a plurality of categories and/or the second to-be-processed point cloud data corresponding to game objects of a plurality of categories; or
the point cloud completion network comprises a third point cloud completion network and a fourth point cloud completion network, and the third point cloud completion network is configured to complete the first to-be-processed point cloud data corresponding to a first category of game participant, and the fourth point cloud completion network is configured to complete the second to-be-processed point cloud data corresponding to a second category of game object.

14. A computer device, comprising a memory, a processor and a computer program stored on the memory and executable on the processor, when the computer program is executed by a processor, the method according to claim 1 is implemented.
